(19) United States
(12) Patent Application Publication
(10) Pub. No.: US 2010/0175343 A1
(43) Pub. Date: Jul. 15, 2010

(54) FLOOR PANEL MADE OF MDF OR HDF

(75) Inventors: Juliane Kruesemann, Ludwigshafen (DE); Ralph Lunkwitz, Neustadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/376,789

(22) PCT Filed: Aug. 8, 2007
(86) PCT No.: PCT/EP07/58234

§ 371 Date: Feb. 9, 2009

(30) Foreign Application Priority Data
Aug. 10, 2006 (DE) 10 2006 037 416.9

(51) Int. Cl. E04C 2/38; E04B 5/00; B32B 37/00

(52) U.S. Cl. 52/588.1; 52/745.13; 156/60

(57) ABSTRACT

The present invention relates to the use of MDF or HDF for the production of a floor panel which comprises a core of MDF or HDF, a backing and, if appropriate, a protective layer, the decorative layer otherwise usual in the case of laminate floor coverings preferably being dispensed with. Furthermore, the present invention relates to floor panels which are produced with the use according to the invention of MDF or HDF, and floor coverings which comprise the floor panels according to the invention.

The present invention relates to the use of MDF or HDF for the production of a floor panel which comprises a core of MDF or HDF, a backing and, if appropriate, a protective layer, the decorative layer otherwise usual in the case of laminate floor coverings preferably being dispensed with. Furthermore, the present invention relates to floor panels which are produced with the use according to the invention of MDF or HDF, and floor coverings which comprise the floor panels according to the invention.

In the area of floor coverings, wood floors and wood-like floor coverings are becoming more and more popular. In particular, the introduction of the so-called click joint, by means of which, for example, laminate and prefinished parquet can be laid without requiring a great deal of time and complicated apparatuses, has led to increased use of this type of floor coverings. The most economical variant is in general laminate.

Laminate usually consists of four layers, a core of HDF or MDF, a backing layer on the bottom, a decorative paper on the top and a so-called overlay, which is a resistant special coating. Decorative papers used are printed paper, predominantly simulating wood structures, such as, for example, beech or maple, or monochrome printed coating materials. The printed paper is impregnated with melamine resin and pressed together with the overlay and also resin-impregnated backing paper with heat and pressure on the core. In direct coating, the four layers—backing, core, decorative paper and overlay—are pressed in one step.

Laminate panels which have a colored core which serves for identifying the moisture resistance are available on the market. The panels are likewise equipped with a decorative paper, and the colored core is not visible after laying.

In spite of the appearance of wood due to the printed decorative paper, laminate differs from genuine wood as floor covering, for example, in the haptic properties and electrostatic charge buildup. This difference is also evident when the floor covering is damaged. If this is not merely superficial but the decorative layer present under the protective layer is affected, the damage virtually cannot be eliminated unless the relevant part is completely replaced.

An object of the present invention is a floor covering which is simple to lay, resembles genuine wood as closely as possible in processing, gives a similar impression to genuine wood in haptic properties and is tolerant to damage to the surface, i.e., damage should not be evident immediately and should as far as possible be capable of being eliminated without replacement. The costs should not exceed those of conventional floor coverings.

The object is achieved by using HDF or MDF for the production of a floor panel which is provided with a groove on a longitudinal side and a transverse side and with a tongue fitting the groove on the respective opposite longitudinal side and transverse side, comprising

A a core of HDF or MDF, and
B a backing layer on the bottom
wherein the presence of a decorative layer is ruled out.

According to a preferred embodiment of the invention, the presence of a decorative layer which is added to the floor panel in the form of a printed or colored paper or coating material is preferably ruled out. Also applying a decorative layer by complete printing the core in such a manner, that the core is completely covered is preferably ruled out according to the present invention.

In a further preferred embodiment, the HDF or MDF used as core A is colored. An embodiment is preferred as well, wherein the floor panel comprises a transparent protective layer on the top of the panel.

HDF and MDF are wood-base materials which have a very homogeneous structure in all three dimensions and as a result of this are readily processible and visually very uniform. MDF and HDF can be processed in the same way as genuine wood, for example by sawing, cutting or drilling; as in the case of genuine wood, edges and profiles can be incorporated. They have mechanical properties which are very similar to those of genuine wood.

The omission of the decorative layer is particularly advantageous. The surface of the floor panels according to the invention is determined by the structure and the properties of the MDF and HDF boards used as core A or the protective layer C which was applied if appropriate. The floor panels according to the invention are therefore very much more similar than conventional laminate to wood with regard to haptic properties. These HDF- and MDF-containing floor panels according to the invention can be surface-treated in the same way as parquet by waxing or varnishing. Since the MDF or HDF core has this very homogeneous structure, the surface therefore does not differ from the underlying layers—in contrast to conventional laminate having a decorative layer—damage to the surface in the case of the floor panels according to the invention is scarcely noticeable and can easily be eliminated as in the case of wood. As a result of the homogeneous structure of the MDF or HDF, the floor panels according to the invention can also very easily be given a three-dimensional structure, for example by cutting or stamping. The omission of the decorative layer results in a cost benefit in the production of the floor panels according to the invention.

If colored MDF or HDF is used as core A, a wide range of novel possibilities for esthetic design of floors are opened up by the floor panels according to the invention. Thus, panels of different shades can be combined, but interesting color variations, such as marbled panels, can also be achieved by a suitable choice of the color-imparting components.

The great variety of colors and effects of the floor panels according to the invention permits individual design of the floor. Since the floor panels according to the invention are provided with groove and tongue, they can easily be laid and easily removed and can be laid again in another place.

In the case of the floor panels according to the present invention, the presence of a decorative layer, as usually possessed by a commercially available laminate, is preferably ruled out. In the case of commercial laminate, the decorative layer serves for lamination with the actual core of the floor covering, which consists of HDF or MDF, and gives the floor a completely different type of appearance, for example by imitation of tiles, flagstones, parquet or wood floorboards. This decorative layer is introduced into the laminate during the production process, as a rule in the form of resin-impregnated paper or another coating material to which a decoration has been applied, for example by printing or dyeing. A further method for applying the decorative layer is direct printing on the core, which is completely printed on so that the core is completely covered. In the present invention, customary methods known to the person skilled in the art and used for the finishing and the surface protection of wood or wood-based materials, such as coating with transparent finishes, oiling, waxing, polishing, glazing and staining, are considered to be a decorative layer. In these methods, at least partly transparent layers which do not completely mask the characteristics of the treated substrate, such as, for example, the grain, are applied. Likewise, a surface modified by methods for three-dimensional structuring of surfaces, such as cutting, stamping, embossing or the CNC method, does not count as a decorative layer in the context of the present application.

According to the invention, HDF (high-density fiberboard) or MDF (medium-density fiberboard) is used as core A for the production of the floor panels. These are wood fiber materials which are produced by pressing, at elevated temperatures, wood fibers mixed with binders.

The wood fibers are produced from various raw materials known to the person skilled in the art, for example chips comprising bark-free softwood. After various digestion and comminution steps, the fibers are finely milled in a so-called refiner. The wood fibers obtained are dried in a so-called blowline. For the production of the fiberboards, the wood fibers must be mixed with the binder. This gluing can take place in the blowline, and the glued fibers then pass through a dryer in which they are dried to residual moisture contents of from 7 to 13%. The fibers can also be glued in special mixers after they have been dried in the blowline. Combinations of blowline and mixer are also possible.

The wood fibers can be bleached before or during the production of the wood fiberboards.

In the chemical bleaching of wood fibers, the color-imparting impurities in the wood are destroyed or rendered ineffective by oxidizing and/or reducing chemicals. For example, hydrogen peroxide, ozone, oxygen, salts of hydrohalic acids, such as chlorites, and salts of organic and inorganic peracids, such as peracetates, percarbonates and perborates, especially the alkali metal salts thereof, in particular sodium salts, are suitable for oxidative bleaching, the percarbonates and hydrogen peroxide being preferred. For example, reducing sulfur compounds, such as dithionites, disulfites, sulfites or sulfur dioxide, sulfinic acids and salts thereof, in particular the alkali metal salts and especially the sodium salts, and hydroxycarboxylic acids, such as citric acid and malic acid, are suitable for reductive bleaching. Preferred reducing agents are the disulfites and sulfites, in particular sodium bisulfite, and malic and citric acid.

In terms of process technology, bleaching is expediently effected by a procedure in which aqueous, 5 to 40% strength by weight wood fiber dispersions are treated continuously in countercurrent towers at temperatures of from 90 to 150° C. and pressures of up to 3 bar with aqueous solutions or dispersions of the bleaches. Usually the procedure is effected in the presence of complexing agents, such as EDTA, in order to avoid the degradation of the bleaches by transition metal ions.

According to the present invention, wood fibers which have first been oxidatively bleached and then reductively bleached are preferably used for the production of the wood fiberboards.

Very particularly preferably, the oxidative bleaching is carried out with percarbonates or hydrogen peroxide and the reductive bleaching with sulfites or malic or citric acid.

Advantageously, the bleaching of the fibers is carried out during the board production. For this purpose, the bleaches can be added to the chips during the digestion and comminution steps in the preheater or in the digester. Preferably, complexing agents are also added.

For completing the boards, the glued chips or fibers are then poured to give mats, if desired precompacted while cold and pressed in heated presses at temperatures of from 170 to 240° C. to give boards.

Aminoplasts, such as urea resins and urea-melamine-formaldehyde resins, but also isocyanates, for example diphenylmethane 4-4′-diisocyanate (MDI), may be used as binders.

According to the present invention, MDF having a density from 600 to 850 kg/m³ and HDF having a density of from 800 to 1100 kg/m³ are used. According to this invention, HDF is preferably used as material for the core A.

After the production, the MDF and HDF boards used as core A can also be treated by customary methods known to the person skilled in the art, such as, for example, grinding.

According to a preferred embodiment of the invention, the HDF or MDF used as core A of the floor panel is colored. The coloring is preferably effected by addition of at least one color-imparting component during the production of the wood fiberboards. The at least one color-imparting component is present in the wood fiberboard preferably in a concentration of from 0.001 to 20% by weight, based on absolutely dry fiber (absolutely dry weight of the fibers), particularly preferably from 0.01 to 10% by weight, based in each case on absolutely dry fiber. All dyes, pigments, pigment preparations, colorant formulations and mixtures thereof which are suitable for coloring wood fiberboards and are known to the person skilled in the art can be used as color-imparting components.

The color-imparting components can either be added to the binder during the fiberboard production or applied separately therefrom to the fibers before or after the gluing or mixed with the fibers.

According to a preferred embodiment of the invention, the HDF or MDF used as core A comprises, as a color-imparting component, at least one pigment and, based on the pigment, from 0.1 to 10% by weight of at least one dye.

It is possible to use organic and inorganic pigments and mixtures of organic and inorganic pigments.

The pigments are preferably present in finely divided form. The pigments accordingly usually have mean particle sizes of from 0.1 to 5 μm, in particular from 0.1 to 3 μm and especially from 0.1 to 1 μm.

The organic pigments are usually organic colored and black pigments. Inorganic pigments may likewise be colored pigments (colored, black and white pigments) and luster pigments.

Below, the following may be mentioned as examples of suitable organic colored pigments:

monoazo pigments, disazo pigments, disazo condensation pigments, anthanthrone pigments, anthraquinone pigments, anthrapyrimidine pigments, quinacridone pigments, quinophthalone pigments, diketopyrrolopyrrole pigments, dioxazine pigments, flavanthrone pigments, indanthrone pigments, isoindoline pigments, isoindolinone pigments, isoviolanthrone pigments, metal complex pigments, perinone pigments, perylene pigments, phthalocyanine pigments, pyranthrone pigments, pyrazoloquinazolone pigments, thioindigo pigments and triarylcarbonium pigments.

Suitable inorganic colored pigments are inorganic metal compounds, such as metal oxides and sulfides, which may also comprise more than one metal. These inorganic pigments include titanium dioxide (C.I. Pigment White 6), zinc white, pigment grade zinc oxide; zinc sulfide, lithopone; iron oxide black (C.I. Pigment Black 11), iron manganese black, spinel black (C.I. Pigment Black 27); carbon black (C.I. Pigment Black 7) as white or black pigments. Chromium oxide, chromium oxide hydrate green; chrome green (C.I. Pigment Green 48); cobalt green (C.I. Pigment Green 50); ultramarine green, cobalt blue (C.I. Pigment Blue 28 and 36; C.I. Pigment Blue 72), ultramarine blue, manganese blue, ultramarine violet, cobalt and manganese violet, iron oxide red (C.I. Pigment Red 101), cadmium sulfoselenide (C.I. Pigment Red 108), cerium sulfide (C.I. Pigment Red 265), molybdate red (C.I. Pigment Red 104), ultramarine red, iron oxide brown (C.I. Pigment Brown 6 and 7), mixed brown, spinel and corundum phases (C.I. Pigment Brown 29, 31, 33, 34, 35, 37, 39 and 40), chromium titanium yellow (C.I. Pigment Brown 24), chrome orange; cerium sulfide (C.I. Pigment Orange 75), iron oxide yellow (C.I. Pigment Yellow 42), nickel titanium yellow (C.I. Pigment Yellow 53; C.I. Pigment Yellow 157, 158, 159, 160, 161, 162, 163, 164 and 189), chromium titanium yellow, spinel phases (CA. Pigment Yellow 119), cadmium sulfide and cadmium zinc sulfide (C.I. Pigment Yellow 37 and 35); chrome yellow (C.I. Pigment Yellow 34), bismuth vanadate (C.I. Pigment Yellow 184) can be used as colored pigments.

The HDF or MDF used as core A may also comprise luster pigments.

The luster pigments are lamellar pigments which have one phase or a plurality of phases and whose color play is characterized by the interplay of interference, reflection and absorption phenomena. Aluminum lamellae or aluminum, iron oxide and mica lamellae coated once or several times, in particular with metal oxides, may be mentioned as examples.

According to the invention, the HDF or MDF used as core A may also be colored with a dye. Dyes which are soluble in water or a water-miscible or water-soluble organic solvent are particularly suitable. Cationic and anionic dyes are particularly suitable, cationic dyes being preferred.

Suitable cationic dyes originate in particular from the di- and triarylmethane, xanthene, azo, cyanine, azacyanine, methine, acridine, safranine, oxazine, induline, nigrosine and phenazine series, dyes from the azo, triarylmethane and xanthene series being preferred.

The following may be mentioned as specific examples: C.I. Basic Yellow 1, 2 and 37; C.I. Basic Orange 2; C.I. Basic Red 1 and 108; C.I. Basic Blue 1, 7 and 26; C.I. Basic Violet 1, 3, 4, 10, 11 and 49; C.I. Basic Green 1 and 4; C.I. Basic Brown 1 and 4.

Cationic dyes may also be colorants comprising external basic groups. Suitable examples here are C.I. Basic Blue 15 and 161.

The corresponding color bases can also be used as cationic dyes, in the presence of solubilizing acidic agents. The following may be mentioned as examples: C.I. Solvent Yellow 34; C.I. Solvent Orange 3; C.I. Solvent Red 49; C.I. Solvent Violet 8 and 9; C.I. Solvent Blue 2 and 4; C.I. Solvent Black 7.

Suitable anionic dyes are in particular sulfo-containing compounds from the series consisting of the azo, anthraquinone, metal complex, triarylmethane, xanthene and stilbene series, dyes from the triarylmethane, azo and metal complex (especially copper, chromium and cobalt complex) series being preferred.

The following may be mentioned as specific examples: C.I. Acid Yellow 3, 19, 36 and 204; C.I. Acid Orange 7, 8 and 142; C.I. Acid Red 52, 88, 351 and 357; C.I. Acid Violet 17 and 90; C.I. Acid Blue 9, 193 and 199; C.I. Acid Black 194; anionic chromium complex dyes, such as C.I. Acid Violet 46, 56, 58 and 65; C.I. Acid Yellow 59; C.I. Acid Orange 44, 74 and 92; C.I. Acid Red 195; C.I. Acid Brown 355 and C.I. Acid Black 52; anionic cobalt complex dyes, such as C.I. Acid Yellow 119 and 204, C.I. Direct Red 80 and 81.

Water-soluble dyes are preferred.

Alkali metal cations, such as Li⁺, Na⁺, K⁺, ammonium and substituted ammonium ions, in particular alkanolammonium ions, may be mentioned in particular as cations imparting water solubility.

In a preferred embodiment, the HDF or MDF used as core A comprises, as a color-imparting component, at least one pigment and, based on the pigment, from 0.1 to 10% by weight of at least one dye.

The dyes used preferably have a hue comparable in each case with the pigments since in this way particularly intense coloring of the wood-based materials is achievable. However, it is also possible to use dyes differing in hue, with the result that shades of the dyeing are possible.

In a particularly preferred embodiment of the invention, the MDF and HDF boards used for the core A of the floor panels are colored by means of a liquid colorant formulation. This colorant formulation is described in detail in WO 2004/035276. The colorant formulation comprises

i at least one pigment
ii at least one dye
iii at least one dispersant
iv water or a mixture of water and at least one water retention agent and
v if appropriate, further constituents customary for colorant formulations.

As a rule, the colorant formulations to be used comprise from 10 to 70% by weight, preferably from 10 to 60% by weight, of pigment.

The dye is present in the colorant formulation to be used in general in amounts of from 0.1 to 10% by weight, preferably from 1 to 8% by weight, based in each case on the pigment. Based on the total weight of the formulation, this corresponds to amounts of, as a rule, from 0.01 to 7% by weight, especially from 0.1 to 5.6% by weight. The colorant formulations to be used usually have a dispersant content of from 1 to 50% by weight, in particular from 1 to 40% by weight.

The statements made above for the pigments and dyes to be used according to the invention are applicable for the dyes and pigments which can be used in the colorant formulation.

Particularly suitable dispersants are nonionic and anionic surface-active additives and also mixtures of these additives.

Preferred nonionic surface-active additives are based in particular on polyethers.

In addition to the unmixed polyalkylene oxides, preferably C₂-C₄-alkylene oxides and phenyl-substituted C₂-C₄-alkylene oxides, in particular polyethylene oxides, polypropylene oxides and poly(phenylethylene oxides), especially block copolymers, in particular polymers having polypropylene oxide and polyethylene oxide blocks or poly(phenylethylene oxide) and polyethylene oxide blocks, and also random copolymers of these alkylene oxides are suitable.

Anionic surface-active additives are based in particular on sulfonates, sulfates, phosphonates or phosphates.

A further important group of anionic surface-active additives comprises the sulfonates, sulfates, phosphonates and phosphates of the polyethers mentioned as nonionic additives.

Further suitable anionic surface-active additives are based on water-soluble polymers comprising carboxylate groups. These can advantageously be adapted to the respective intended use and the respective pigment by adjusting the ratio of polar and nonpolar groups present.

Water forms the liquid carrier material of the colorant formulations to be used according to the invention.

The colorant formulations preferably comprise a mixture of water and a water retention agent as the liquid phase. Water retention agents used are in particular organic solvents which are poorly vaporizable (i.e. as a rule have a boiling point >100° C.), are therefore water-retaining and are soluble in water or miscible with water.

Examples of suitable water retention agents are polyhydric alcohols, preferably straight-chain and branched polyhydric alcohols having 2 to 8, in particular 3 to 6, carbon atoms, such as ethylene glycol, 1,2- and 1,3-propylene glycol, glycerol, erythritol, pentaerythritol, pentitols, such as arabitol, adonitol and xylitol, and hexitols, such as sorbitol, mannitol and dulcitol. Furthermore, for example, di-, tri- and tetraalkylene glycols and monoalkyl (especially C₁-C₆-alkyl, in particular C₁-C₄-alkyl)ethers thereof are also suitable. Di-, tri- and tetraethylene glycol, diethylene glycol monomethyl, monoethyl, monopropyl and monobutyl ether, triethylene glycol monomethyl, monoethyl, monopropyl and monobutyl ether and di-, tri- and tetra-1,2- and -1,3-propylene glycol and di-, tri- and tetra-1,2- and -1,3-propylene glycol monomethyl, monoethyl, monopropyl and monobutyl ether may be mentioned by way of example.

As a rule, the colorant formulations to be used according to the invention comprise from 10 to 88.95% by weight, preferably from 10 to 80% by weight, of water or a mixture of water and water retention agent. If water is present as a mixture with water-retaining organic solvent, this solvent accounts in general for from 1 to 80% by weight, preferably from 1 to 60% by weight, of the phase.

Furthermore, the colorant formulations may also comprise conventional additives, such as biocides, antifoams, antisettling agents and rheology modifiers, the proportion of which can in general be up to 5% by weight.

The colorant formulations to be used according to the invention can be obtained in various ways. Preferably, a pigment dispersion is first prepared, to which the dye is then added as a solid or in particular in dissolved form.

The colorant formulations are outstandingly suitable for coloring MDF and HDF boards.

The colorant formulations to be used according to the invention may be added in various ways and at different points of the manufacturing process to the mixture serving as a basis for the MDF and HDF boards and comprising wood fibers and binder.

With the use of binders based on aminoplasts, such as urea resins and urea-melamine-formaldehyde resins, the colorant formulations can be applied to the wood fibers or wood chips together with the binder, which is usually used in the form of a dispersion comprising further additives, such as curing agents and paraffin dispersions, or separately from the binder before or after the gluing. With the use of isocyanates (MDI) as binders, the colorant formulations are used separately from the binder. In the case of gluing with combinations of aminoplasts and isocyanates, the colorant formulations can, if desired, be added to the aminoplast component.

The HDF or MDF used as core A can be colored completely in one shade.

Particularly attractive color effects are achievable by mixing different colored fibers and then pressing. For example, marbled or mottled boards can be obtained thereby. Particular effects can be obtained by multicolored coloring of the boards. For example, differently colored fibers can be pressed in a stratified manner. Such effects can also be achieved if only a part of the fibers is colored and the other part retains its original color.

Furthermore, electrically conductive MDF and HDF boards which are of interest, for example, for electrically conductive floor panels can also be produced by coloring with electrically conductive colorant formulations comprising carbon black.

The floor panels produced according to the invention with the use of MDF or HDF comprise a backing B. All materials known to the person skilled in the art for this purpose can be used as backing B; for example, the backing B may be a paper which is impregnated with melamine resin and pressed onto the bottom of the HDF and MDF boards.

If appropriate, the floor panels produced according to the invention with the use of MDF or HDF comprise a protective layer C which is also referred to as an overlay. This protective layer may be a transparent paper impregnated with melamine resin and pressed onto the top of the MDF and HDF boards. If the floor panels according to the invention are provided with a protective layer, the backing and the protective layer are preferably applied in one step. Before or after the application of the backing B and, if appropriate, of the protective layer C, the surface can be processed, for example, by means of stamping, embossing, CNC methods, punching or cutting so that the board acquires a structured surface. In this way, so-called “living surfaces” which very closely resemble the surface of genuine wood can be achieved. Deep joint profiles can also be cut in.

If the floor panel is not provided with a protective layer in the form of an overlay, the surface can be subjected to other surface treatments. The surface may be simply only ground, waxed, oiled, stained, glazed or varnished. In general, all methods and materials known from the surface protection of parquet can also be used for the surface treatment of the floor panels according to the invention, for example UV-curable finishes, powder coatings and other transparent surface coatings. Before the surface treatment, the surface can be provided with a three-dimensional structure, for example by means of stamping, embossing, CNC methods, punching or cutting. In a further embodiment of the invention, the surface of the floor panel is only three-dimensionally structured and no further surface treatment is carried out.

The floor panels according to the invention may also comprise further layers. For example, footfall insulation or heat insulation may be applied to the bottom of the floor panels.

The MDF and HDF boards provided with the backing B and, if appropriate, the protective layer C are divided into commercial dimensions and provided with a groove on a longitudinal side and a transverse side and with a tongue fitting the groove on the respective opposite longitudinal side and transverse side. This can be carried out, for example, by means of cutting.

The invention also relates to the floor panels produced according to claims 1 to 11 and floor coverings which comprise the floor panels according to the invention.

### EXAMPLES

### 1. Preparation of the Colorant Formulations

The following colorant formulations were used for coloring the particleboards and fiberboards:

### 1.1. Green Colorant Formulation

A mixture of 25% by weight of a green pigment formulation, which is prepared by wet milling
40% by weight of C.I. Pigment Green 7
8% by weight of a block copolymer based on ethylenediamine/propylene oxide/ethylene oxide having an ethylene oxide content of 40% by weight and an average molecular weight Mₙ of 6500
15% by weight of dipropylene glycol
37% by weight of water
   in a stirred ball mill, and 7% by weight of a 47% strength by weight solution of C.I. Basic Green 7 in 48% strength by weight acetic acid and 68% by weight of water is prepared.

### 1.2. Red Colorant Formulation

The mixture is obtained by wet milling
26% by weight of C.I. Pigment Red 48:2
5% by weight of C.I. Direct Red 80
24% by weight of a 26% strength by weight ammoniacal solution of an acrylic acid/styrene copolymer having an acid number of 216 mg KOH/g and an average molecular weight Mₙ of 9200
5% by weight of dipropylene glycol
40% by weight of water
   in a stirred ball mill.

### 1.3. Black Colorant Formulation

A mixture of 94% by weight of a black pigment formulation, which is prepared by wet milling
40% by weight of C.I. Pigment Black 7
10% by weight of a block copolymer based on ethylenediamine/propylene oxide/ethylene oxide having an ethylene oxide content of 40% by weight and an average molecular weight Mₙ of 12 000
22% by weight of dipropylene glycol
28% by weight of water
   in a stirred ball mill, and 6% by weight of a 10% strength by weight solution of C.I. Basic Violet 3 in 30% strength by weight acetic acid is prepared.

### 1.4. Blue Colorant Formulation

A mixture of 90% by weight of a blue pigment formulation, which is prepared by wet milling
40% by weight of C.I. Pigment Blue 15:1
8% by weight of a block copolymer based on ethylenediamine/propylene oxide/ethylene oxide having an ethylene oxide content of 40% by weight and an average molecular weight Mₙ of 6700
10% by weight of dipropylene glycol
42% by weight of water
   in a stirred ball mill, and 10% by weight of a 10% strength by weight solution of C.I. Basic Violet 4 in 30% strength by weight acetic acid is prepared.

### 1.5. Conductive Black Colorant Formulation

A mixture of 98% by weight of a black pigment formulation, which is prepared by wet milling
20% by weight of conductive carbon black
10% by weight of a block copolymer based on ethylenediamine/propylene oxide/ethylene oxide having an ethylene oxide content of 40% by weight and an average molecular weight Mₙ of 12 000
70% by weight of water
   in a stirred ball mill, and 2% by weight of a 10% strength by weight solution of C.I. Basic Violet 3 in 30% strength by weight acetic acid is prepared.

### 2. Production of Colored MDF Boards

For the production of the MDF boards, the glue batches mentioned in tables 1 and 2 are used, unless stated otherwise:

TABLE 1

| Urea-melamine-formaldehyde resin, | 100.0 | parts by weight |
|---|---|---|
| 66.5% strength in water | | |
| Paraffin dispersion, 60% strength in water | 4.0 | parts by weight |
| Colorant formulation and water | 54.3 | parts by weight |
| Solid resin content of the liquor | 42% | |
| Solid resin/absolutely dry fibers | 14% | |
| Liquor based on 100 kg of absolutely dry | 33.3 | kg |
| fibers | | |

TABLE 2

| Urea-melamine-formaldehyde resin, | 100.0 | parts by weight |
|---|---|---|
| 66.5% strength in water | | |
| Paraffin dispersion, 60% strength in water | 4.0 | parts by weight |
| Colorant formulation No. 1.5 | 19.0 | parts by weight |
| Water | 35.3 | parts by weight |
| Solid resin content of the liquor | 42% | |
| Solid resin/absolutely dry fibers | 14% | |
| Liquor based on 100 kg of absolutely dry | 33.3 | kg |
| fibers | | |

### 2.1. Production of a Black MDF Board

19.0 parts by weight of the colorant formulation No. 1.3 are added to the glue batch from table 1.

The fibers treated with glue are then dried in a dryer to a moisture content of about 8% by weight, poured to give a mat, precompacted, and pressed at 220° C. to give a board.

The MDF board obtained shows a homogeneous, brilliant, lightfast black dyeing.

### 2.2. Production of a Black, Isocyanate-Bound MDF Board

The fibers are treated with 3.5% by weight of isocyanate (MDI), which was emulsified immediately before the glue treatment in water (weight ratio 1:1), as a glue. Separately therefrom, 4% by weight of the colorant formulation No. 1.3 and 0.8% by weight of the paraffin dispersion are mixed with the fibers.

The fibers treated with glue are then dried in a dryer to a moisture content of about 8% by weight, poured to give a mat, precompacted, and pressed at 220° C. to give a board.

The MDF board obtained shows a homogeneous, brilliant, lightfast black dyeing.

### 2.3. Production of a Blue MDF Board

4.7 parts by weight of the colorant formulation No. 1.4 are added to the glue batch from table 1.

The fibers treated with glue are then dried in a dryer to a moisture content of about 8% by weight, poured to give a mat, precompacted, and pressed at 220° C. to give a board.

The MDF board obtained shows a homogeneous, brilliant, lightfast blue dyeing.

### 2.4. Production of a Red MDF Board

4.7 parts by weight of the colorant formulation No. 1.2 are added to the glue batch from table 1.

The fibers treated with glue are then dried in a dryer to a moisture content of about 8% by weight, poured to give a mat, precompacted, and pressed at 220° C. to give a board.

The MDF board obtained shows a homogeneous, brilliant, lightfast red dyeing.

### 2.5. Production of a Green MDF Board

2.4 parts by weight of the colorant formulation No. 1.1 are added to the glue batch from table 1.

The fibers treated with glue are then dried in a dryer to a moisture content of about 8% by weight, poured to give a mat, precompacted, and pressed at 220° C. to give a board.

The MDF board obtained shows a homogeneous, brilliant, lightfast green dyeing.

### 2.6. Production of a Blue-Black Marbled MDF Board

Fibers treated with glue and dried analogously to 1.1 and 1.3 are mixed in a paddle mixer in a blue:black weight ratio of 3:1, then poured to give a mat, precompacted, and pressed at 220° C. to give a board.

The MDF board obtained shows a blue-black marbled effect.

### 2.7. Production of an MDF Board Colored Blue-Black in a Stratified Manner

Blue chips treated with glue and dried analogously to 2.3 are poured to give a mat and precompacted while cold. Black fibers treated with glue and dried analogously to 2.1 are poured thereon and likewise precompacted. The mats are then pressed at 220° C. to give a board.

The MDF board obtained shows a homogeneous, brilliant blue dyeing on one side and a homogeneous, brilliant black dyeing on the other side.

### 2.8. Production of a Blue-Black Marbled MDF Board

Fibers treated with glue and dried analogously to 2.1 and 2.3 are mixed in a paddle mixer in a blue:black weight ratio of 3:1, then poured to give a mat, precompacted, and pressed at 220° C. to give a board.

The MDF board obtained shows a blue-black marbled effect.

### 2.9. Production of a Blue-Green-Red Marbled MDF Board

Fibers treated with glue and dried analogously to 2.3, 2.4 and 2.5 are mixed in a paddle mixer in a blue:green:red weight ratio of 1:1:1, then poured to give a mat, precompacted, and pressed at 220° C. to give a board.

The MDF board obtained shows a blue-green-red marbled effect.

### 2.10. Production of a Black, Conductive MDF Board

The glue batch from table 2 is used.

The fibers treated with glue are then dried in a dryer to a moisture content of about 8% by weight, poured to give a mat, precompacted, and pressed at 220° C. to give a board.

The MDF board obtained shows a homogeneous, brilliant, lightfast black dyeing and has a surface resistance of 1.3×10⁵ Ωcm.

### 3

In order to provide the colored MDF boards produced according to examples 1 and 2 with a backing, paper having a weight of from 90 to 110 g/m² is impregnated with a 55% strength by weight aqueous solution of melamine-formaldehyde resin having a molecular melamine:formaldehyde ratio of 1:1.6, applied to the bottom of the colored MDF boards produced according to examples 1 and 2 and hot-pressed at 190° C. and 20 bar for 20 seconds.

Thereafter, the boards provided with a backing are divided into rectangles measuring about 10 cm×15 cm and a groove is cut into each of two adjacent edges and the tongues fitting said groove are cut into the edges opposite thereto.

1-12. (canceled)

13. A method for producing a floor panel which is provided with a groove on a longitudinal side and a transverse side and with a tongue fitting the groove on the respective opposite longitudinal side and transverse side, comprising the step of providing
A a core of HDF or MDF, prepared from fibers, comprising at least one pigment and, based on the pigment, from 0.5 to 10% by weight of at least one dye with
B a backing layer on the bottom, thereby eliminating the necessity of a decorative layer.

14. The method according to claim 13, the presence of a decorative layer which is added to the floor panel in the form of a printed or colored paper or coating material or by complete printing is eliminated.

15. The method according to claim 13, wherein the floor panel comprises a transparent protective layer on the top.

16. The method according to claim 13, wherein the core A comprises from 0.001 to 20% by weight of at least one color-imparting component, based on the weight of fibers of the dry fiber core of HDF or MDF.

17. The method according to claim 13, wherein the core A is colored with the aid of a colorant formulation comprising
i at least one pigment
ii at least one dye
iii at least one dispersant
iv water or a mixture of water and at least one water retention agent and
v optionally, other constituents customary for inclusion in colorant formulations.

18. The method according to claim 13, wherein the core A consists of HDF having a density ranging from 800 to 1100 kg/m³.

19. The method according to claim 13, wherein the floor panel has acquired a three-dimensional surface structure.

20. The method according to claim 13, wherein the floor panel comprises a backing layer B in the form of a paper impregnated with resin.

21. The method according to claim 13, wherein the floor panel comprises a protective layer C in the form of a transparent paper impregnated with resin.

22. The method according to claim 13, wherein the floor panel is subjected to a surface treatment.

23. A floor panel produced by the method according to claim 13.

24. A floor covering comprising the floor panels according to claim 23.
